(19) United States
(12) Patent Application Publication
(10) Pub. No.: US 2014/0283593 A1
(43) Pub. Date: Sep. 25, 2014

(54) METHOD AND SYSTEM FOR DOWNHOLE ANALYSIS

(71) Applicant: SCHLUMBERGER TECHNOLOGY CORPORATION, SUGAR LAND, TX (US)

(72) Inventors: NEIL WILLIAM BOSTROM, SALT LAKE CITY, UT (US); ROBERT LEONARD KLEINBERG, CAMBRIDGE, MA (US); KRISTOFER GUNNAR PASO, RIDGEFIELD, CT (US); BHAVANI RAGHURAMAN, PRINCETON JUNCTION, NJ (US); GORDON R. LAMBERTUS, INDIANAPOLIS, IN (US)

(21) Appl. No.: 14/296,863

(22) Filed: Jun. 5, 2014

Related U.S. Application Data
(63) Continuation of application No. 12/248,545, filed on Oct. 9, 2008.
(60) Provisional application No. 61/015,293, filed on Dec. 20, 2007.

(51) Int. Cl. G01N 30/62; G01N 30/28; G01V 9/00

(52) U.S. Cl. CPC G01N 30/62; G01V 9/00; G01N 30/28
USPC 73/152.18

(57) ABSTRACT

Advanced remote self-contained chromatographic systems and techniques for analyzing a mixture comprising components having a wide range of boiling points. The chromatographic systems and techniques can utilize components and techniques that allow staged, simultaneous, and/or sequential vaporization of an analyte to facilitate rapid analysis. The chromatographic systems and techniques can also utilize components and techniques that focus eluents from a first separation stage prior to reduce characterization time in subsequent stages.

### CROSS REFERENCE TO RELATED APPLICATION

This application is a continuation of U.S. patent application Ser. No. 12/248,545 filed Oct. 9, 2008; which claims the benefit of U.S. Provisional Patent Application Ser. No. 61/015,293 filed Dec. 20, 2007. Both of these applications are incorporated herein by reference in their entireties.

### BACKGROUND OF INVENTION

1. Field of Invention

The present invention relates to analytical systems and techniques such as those involving chromatographic analysis and, more particularly, to downhole or well bore analysis utilizing chromatographic systems having a plurality of separation stages.

2. Background of the Invention

Chromatographic systems have been disclosed. For example, Andelman, in U.S. Pat. No. 5,360,540, discloses a chromatography system for the purification of fluid-containing material.

Various techniques for chromatographic analysis have been further disclosed. Phillips et al., in U.S. Pat. No. 5,135,549, disclose two-dimensional gas chromatography. Klein et al., in U.S. Pat. No. 5,032,151, disclose a system and method for automated cool on-column injection with column diameters less than 530 μM. Seeley, in U.S. Patent Application Publication No. US 2002/0148353, discloses a method and apparatus for comprehensive two-dimensional gas chromatography. Munari et al., in U.S. Patent Application Publication No. US 2002/0178912, disclose a chromatography apparatus with direct heating of the capillary column. Tian et al., in U.S. Patent Application Publication No. US 2004/0056016 disclose a microelectromechanical heating apparatus and fluid pre-concentrator device. Cai et al., in U.S. Patent Application Publication No. US 2005/0048662, disclose partial modulation via a pulsed flow modulator for comprehensive two-dimensional liquid or gas chromatography.

Chromatographic analysis has been used to evaluate oil and/or formation fluids. For example, Pilkington et al., in U.S. Pat. No. 4,739,654, disclose a method an apparatus for downhole chromatography. Guize et al., in U.S. Pat. No. 4,864,843, disclose a method and apparatus for chromatographic analysis of petroleum liquids. Guieze, in U.K. Patent Application Publication No. GB 2 254 804, discloses hydrocarbon chromatography. Eisenmann, in U.S. Pat. No. 5,304,494, discloses a method of analyzing hydrocarbon oil mixtures using gel-permeation chromatography.

Existing chromatographic analysis of a gas-rich reservoir fluid is relatively complex. The reservoir fluid is first isothermally separated into a liquid fraction and a gas fraction, to atmospheric pressure. The gas fraction includes mostly low boiling point components whereas the liquid fraction includes relatively higher boiling point components as well as molecules or compounds that cannot be analyzed using gas chromatography techniques, such as asphaltenes. Thus, each of the liquid and gas samples are typically analyzed separately, in some cases using different columns, at various conditions, e.g., flow rates and temperature programs. For example, the liquid fraction is analyzed with a “faster” separation column at conditions which incapable of separating components in the gas fraction. This approach facilitates elution of the heavier components, from the respective column, in a reasonable amount of time. The gas fraction analysis typically utilizes columns at a set of conditions that are relatively “slower” to adequately separate components. Most laboratories, however, utilize only one column to perform each of the analysis steps, without any attempts to analyze the entire crude oil in a single step or concurrently.

If, however, a sample is analyzed in a column under conditions that are too slow, the retention times are excessively long. In extreme cases one or more of the components will elute from the column during subsequent separation attempts. Moreover, since the peak width is proportional to the square root of the retention time, long retention times result in peak broadening to the point where they are difficult to distinguish from the base line. On the other hand, if a sample is analyzed in a column under conditions that are too fast, all the components exit the column at nearly the same time resulting in inadequate characterization and/or quantification of the components therein.

With respect to fluids encountered in a hydrocarbon reservoir (herinafter reservoir fluids or formation fluids), the components that elute early are typically more difficult to separate. To address this behavior in single stage chromatography, the column is maintained at a low initial temperature, for example, at about 40° C., until the early components have eluted. The column temperature is then increased to reduce the overall analysis time so as to promote elution of the later-eluting components. The relatively low temperature increases the separation of the early eluting components and the higher temperature reduces the elution time of the later, heavier components.

To further reduce the number of required injection and separation cycles and consequently the total analysis time for a sample, a two-column or two-stage approach can be used. First, a relatively fast column can be used under conditions that provide an initial separation. As a set of partially separated components of interest elute, they are directed to a second column for further separation under conditions that further promote separation. All other components can be diverted to a detector or out of the chromatographic system as they elute from the first column or first stage.

The carrier gas flow conditions can also be adjusted to accelerate analyses. Instead of increasing the temperature to reduce retention times, the flow rate of the mobile phase can be increased using, for example, electronic pressure controllers. Notably, flow rate programs or schedules have not been implemented or even suggested for downhole chromatographic analytical systems in the prior.

In some applications, molecular components having long retention times are of little interest. In such cases, the slowest components may have progressed only a small fraction of the length of the column during the time in which the more pertinent components have completely transited the column. One technique to accelerate removal of such inconsequential components, without waiting for them to transit through the column involves reversing the direction of carrier gas flow or back flushing.

### SUMMARY OF THE INVENTION

In one or more embodiments, the invention provides a chromatography system having a plurality of stages in communication with a formation fluid, as well as one or more detectors in communication with the plurality of stages. The chromatography system can comprise at least one vaporizing chamber operatively coupled to at least one of the plurality of stages, and to a source of formation fluid in a well bore; one modulator comprising a stationary phase, the modulator in fluid communication with at least one of an outlet of one of the plurality of stages.

In other embodiments, the invention provides a method of chromatographic analysis of a formation fluid using a plurality of stages and at least one detector. In accordance with aspects the apparatus and method can be utilized in surface or subsurface environment including the use of the method and apparatus in downhole hydrocarbon analysis.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIGS. 1A and 1B are schematic diagrams illustrating analytical systems in accordance with some embodiments of the invention;

FIGS. 2A and 2B are schematic diagrams illustrating parallel/sequential (FIG. 2A) and parallel/simultaneous (FIG. 2B) configurations of analytical systems of the invention;

FIG. 3 is a schematic diagram of a chromatographic system, in accordance with some embodiments of the invention, involving filtration subsystems that allow a selected, particular, or targeted range of components into particular chromatographic trains;

FIG. 4 is a schematic diagram illustrating an analytical system of the invention without any stationary phases;

FIG. 5 is a schematic diagram illustrating a portion of a sampling stage of the systems of the invention that advantageously allows controlled expansion of an analyte pertinent to some embodiments of the invention;

FIG. 6 is a schematic diagram illustrating a portion of a chromatographic analytical system, in accordance with some embodiments of the invention, that involves parallel and/or simultaneous vaporization and characterization of portions of a sample to be characterized;

FIG. 7 is a schematic diagram illustrating a portion of a chromatographic analytical system, in accordance with some embodiments of the invention, that involves sequential vaporization and parallel characterization of portions of a sample to be characterized;

FIG. 8 is a schematic diagram illustrating a portion of a chromatographic system in accordance with some embodiments of the invention that involve aspects pertinent to modulating a first eluent from a first chromatographic column for further characterization in a second chromatographic train;

FIG. 9 is a schematic illustration of a cross-section of a tubular chemical modulator in accordance with some embodiments of the invention;

FIG. 10 illustrates the focusing effect of a modulator in accordance with some embodiments of the invention;

FIG. 11 is a schematic diagram illustrating a portion of a modulator assembly in accordance with some embodiments of the invention;

FIG. 12 is a schematic diagram illustrating a serially connected chromatographic train in accordance with some embodiments of the invention;

FIG. 13 is a schematic diagram illustrating a flow control utilizing a Deans switch;

FIGS. 14A and 14B are schematic diagrams illustrating controlling the flow of streams in a chromatographic system in accordance with some embodiments of the invention;

FIG. 15 is a copy of a chromatogram of a sample analyzed utilizing a single column; and

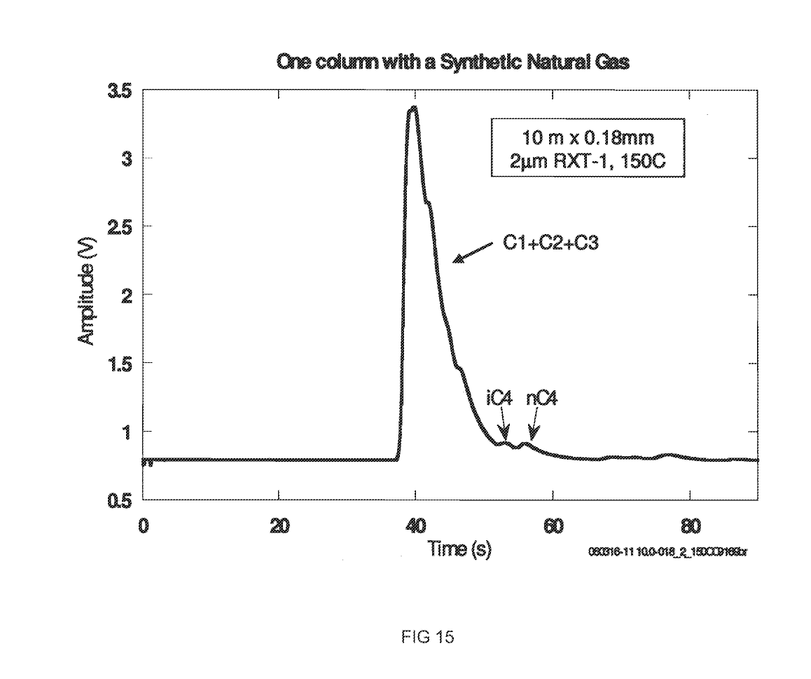

FIG. 16 is a copy of a chromatogram of a sample, having the same composition of the sample as analyzed with respect to FIG. 15, analyzed utilizing the staged chromatographic trains in accordance with some embodiments of the invention.

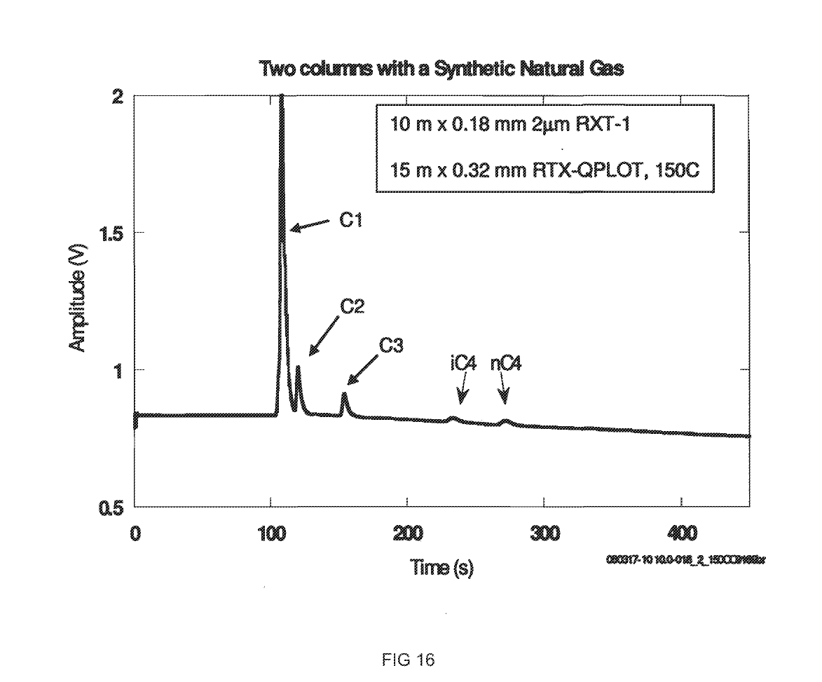

### DETAILED DESCRIPTION OF THE PREFERRED EMBODIMENTS

The invention is directed to chromatographic systems and techniques. The invention is not limited in its application to the details of construction and the arrangement of components set forth in the following description or illustrated in the drawings. The invention is capable of embodiments and of being practiced or of being carried out in various ways beyond those exemplarily presented herein, including but not limited to application on the surface as well as application located downhole.

Further advantageous features of the invention are directed to systems and techniques that separate the components of the analyte in a single apparatus or an apparatus that houses or contains all or substantially all of the pertinent components involved in providing a characterization of the analyte. In some cases, the singly-housed or integrated analytical apparatus of the invention can be disposed down hole, in a well bore or a reservoir, and be considered a self-contained system that transmits a characteristic representation of the analyte to a surface facility.

As discussed further below, systems and techniques directed to rendering the analyte in the gaseous phase can be considered to involve one or more features or aspects of the invention. Although the description herein of the systems and techniques of the invention are typically directed to a formation fluid, the invention, however, is not limited to characterizing only formation fluids and can be utilized to characterize other types of fluids including drilling fluids, treatment fluids, well-bore fluids, and mixtures thereof.

Some aspects of the invention are directed to advanced chromatographic analysis of complex, multi-component fluid mixtures. Complex fluid mixtures typically have components over a wide range of boiling points or vapor pressures including permanent gases and high molecular weight components. Crude oils or formation fluids are examples of such mixtures.

Some particular aspects of the invention are relevant to gas chromatography, typically with one or more chromatographic columns that facilitate separation of an analyte comprising a plurality of components. The one or more chromatographic columns utilized in the systems and techniques of the invention typically comprise or define a stationary phase through which a mobile phase traverses. The mobile phase or mixture typically comprises a carrier fluid which can be comprised of one or more inert gases. For example, helium gas can serve as a carrier gas of the mobile phase and chromatographic analysis can be performed by transporting the analyte through the stationary phase by the carrier gas.

As the analyte is introduced, also referred to as injecting, it progresses through the column and the components thereof interact with the stationary phase. Typically, the interaction differences between the various mobile components and the stationary phase matrix effects separation of the mobile components. One or more factors can influence or provide the separation effect. Components of the mobile mixture typically interact with the stationary phase according to the affinity of the mobile components to the matrix of the stationary phase material. For example, depending on the combination of the analyte components and the matrix material, the interaction can be influenced by relative charges and/or solubilities of the mobile components in the stationary phase material. In some cases, however, the separation phenomena can also be based on size and/or adsorption of the mobile components relative to or onto the stationary phase. Some aspects of the invention can also facilitate subsurface analysis of formation fluids. Subsurface formation fluids are typically under high pressure, relative to surface conditions, and are consequently in liquid state. Particular aspects of the invention, therefore, can involve systems and techniques that facilitate the characterization of the formation liquid by vaporizing the formation liquid. Some embodiments of the invention, in accordance with such aspects, involve vaporizing or rendering at least a portion of the formation fluid into a gaseous phase. Particularly advantageous embodiments of the invention involve controlled or fractional vaporization of the formation fluid. Vaporization may be effected in any suitable way and is not limited to the heating and/or expansion techniques discussed herein.

The advanced gas chromatographic systems and techniques of the invention can be utilized to analyze fluid mixtures having a wide range of boiling points such as, but not limited to, crude oil or formation fluid traversing, for example, a well bore. Some particular embodiments of the advanced systems and techniques utilize a plurality of chromatographic stages or dimensions, one or more of which can be defined, at least partially, by a chromatographic column. Further particularly advantageous advanced embodiments of the invention can utilize subsystems or ancillary components that facilitate retrieving the fluid mixture to be characterized and rendering it suitable for analysis in the chromatographic components described herein. Additional advantageous features of the advanced analytical systems and techniques of the invention provide characterization profiles with relatively short or even instantaneous analysis times. As further described below, various combinations of subsystems and techniques can be utilized to effect the advantageous rapid characterization results in a subsurface environment.

Thus, still further aspects of the invention can be directed to characterizing formation fluid without transporting or delivering such above surface. Some further aspects of the invention involve systems and techniques that accommodate subsurface or essentially in situ characterization of the composition of the formation fluid. Indeed, some particularly advantageous features of the invention provide systems and techniques that facilitate an almost instantaneous analysis of an analyte during, for example, drilling, completion, production, and/or abandonment of an oil well. For example, the chromatographic analytical systems and techniques of the invention may be utilized to analyze the drilling fluid, cuttings, and/or produced hydrocarbons, as gas or oil.

Although the discussion herein focuses on gas chromatographic (GC) techniques some aspects of the invention may involve chromatographic techniques that utilize a mobile phase predominantly, but not limited to, the gas state. Non-limiting examples include High Pressure Liquid Chromatography, Supercritical Fluid Chromatography, Size exclusion chromatography, gel permeation chromatography, a liquid chromatography-gas chromatography system. Thus, in some embodiments of the invention, an analyte, as the material or mixture of compounds to be separated, purified, isolated, or otherwise characterized, can be analyzed in the gaseous state and/or in the liquid state.

The represented invention references a plurality of “stages” and “detectors”, wherein these stages and detectors are necessary in practicing the present invention. As used herein, a stage includes any mechanism capable of determining individual components from a fluid in communication with the stage. One such non-limiting example of a suitable “stage” for use with the present invention is a chromatographic column. Additionally, a “detector” is defined as a device capable of analyzing the output of at least one stage. A detector may include, but is not limited to a Flame Ionizaton Detector (FID), Thermal Conductivity Detector (TCD), or Helium Ionization Detector (HID), etc.

One or more embodiments of the invention involve advanced chromatographic systems that analyze complex fluid mixtures in a gaseous phase. The systems and techniques of the invention can facilitate the separation of components of complex fluids in a continuous and/or integrated approach. In some embodiments of the invention, a series of types of adsorbent materials can be utilized in stages to target or capture a mixture having a volatility range of components. The invention also provides systems and techniques of the invention that facilitate separation and characterization at high temperature environments, e.g., in a downhole location. In some cases, the systems and techniques of the invention may be performed without active cooling requirements and/or consumables, such as cryogenic gases or auxiliary carrier gas flow that further increases the complexity of analytical systems. Thus, because the invention can advantageously reduce the need for ancillary equipment, the present inventive systems can be characterized as having increased reliability and portability as well as reduced cost while providing reproducible and consistent information.

Some aspects of the invention facilitate controlled or regulated fractionation of the analyte. For example, the analyte or portions thereof can be controllably vaporized in one or more vaporization chambers thereby facilitating a staged or multi-dimensional analytical process. As will be discussed further below, the vaporization chamber design can influence the range of components that enter the columns by controlling one or more states of the analyte such as, but not limited to, the temperature and pressure thereof. The various vaporization chambers of the invention can further comprise one or more components that can control the range of components that enter the chromatographic columns. Furthermore, methods and techniques that controllably provide desired vaporization conditions, such as temperature programs, flow rate programs, and back flushing of the stages can be employed to reduce analysis times, improve resolution, and allow flushing of at least one stage of the system of the invention between analyses.

Some aspects of the invention further provide advanced chromatographic assemblies that further improve analytical separation techniques. A general embodiment of such a configuration operate with a modulation device located at the outlet of a chromatographic column. The modulation systems and techniques of the invention can separation and quantification of a many sample constituents. Most commonly these devices are located in the sample flow path, at the outlet of one separation column and prior to the inlet of a second. The function of such a device is to collect, focus, and reinject sample as it elutes from a column. The reinjection of sample can be followed either by a second column, or can be done into a detector. Typically, modulators rely on temperature changes, whereby it traps analytes as the leave the column, with some active cooling mechanism to cool a segment of tubing, or by valve based modulators that rely on switching mechanisms to reinject first column effluent. In one specific arrangement, a chemical adsorbent or absorbent can reside in the segment of tubing used for the modulator. This would facilitate retention or otherwise trap sample as it leaves a column. Such materials, when housed in a modulator, help to efficiently trap material as it passes through the modulator, and can be used to replace sub-ambient cooling used in thermal modulators for efficient trapping of relatively light components. The various chemical adsorbent/absorbent components of the invention can be designed in any number of configurations including, for example, flow-through beds, back-flushable beds, open adsorbent, and/or absorbent-lined tubes, packed tubes, high permeability membranes, and can be housed in fused silica tubing, glass tubing, any kind of metal tubing, or in MEMS-channels. Further, any type of adsorbent/absorbent material can be utilized in the modulator embodiments of the invention. Non-limiting examples of which include molecular sieve materials, diatomaceous earth, porous polymers, and polar/non-polar liquid stationary phases, including cross-linked phases and gums.

Further aspects of the invention pertinent to modulation can be implemented with multi-staged systems having several and/or different types of adsorbent and/or absorbent materials that trap one or more of the components of the analyte. The invention further provides controlled analyte components de-sorption or release. Release of the captured or trapped analyte components can be affected at desired instances or periods by providing conditions that alter the affinity of the captured components and the adsorbent/absorbent media. For example, the temperature of the modulation assembly can be changed, e.g., heating, so as to promote de-sorption. Other techniques that may be utilized to controllably release the captured analyte components can utilize processes such as solvent stripping, pressure programming, or carrier gas flow programming. Peak sharpness and analyte recovery can be further enhanced by configuring two or more chemical modulators in series with a delay loop, such that de-sorption cycles can be timed to assure that the entire eluent flow from the one or more primary or first stage columns enters the one or more subsequent or secondary columns as sharp concentration pulses. The modulation systems and techniques disclosed herein can thus directly replace the conventional cryogenic cooling approach utilized in thermal modulation and movable heater modulation systems In some cases, the modulation systems and techniques of the invention can also provide systems flexibility by implementing component-selective partial modulation by, for example, selectively modulating target components from an eluent stream.

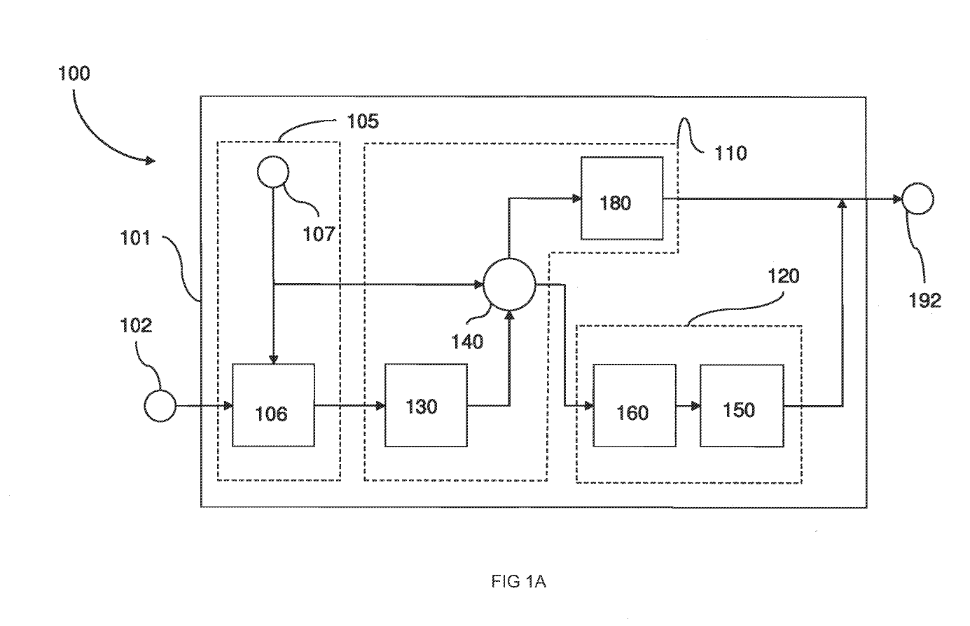

FIGS. 1A and 1B are schematic block diagrams illustrating one or more embodiments of a chromatographic analytical system 100 of the invention. System 100 is typically disposed or placed in service in a subsurface environment, such as, but not limited to, in a well bore. As shown in FIGS. 1A and 1B, analytical system 100 can comprise or contain a plurality of components and/or subsystems in a housing 101. The components and subsystems of system 100 typically include one or more sample handling stages 105, which facilitate retrieval and conditioning of the analyte as retrieved from, for example, a subsurface structure. A primary or first stage 110 of system 100 can also be contained in housing 101, along with one or more optional secondary stages 120.

The sample is introduced into sample handling stage 105 wherein it is conditioned for analysis in the subsequent one or more stages. In stage 105, the state of at least a portion of the analyte is modified to facilitate motility, analysis or characterization. For example, the analyte is typically retrieved from a source 102, which can be a formation or a well bore, as a liquid into stage 105. In stage 105, the analyte can be vaporized in one or more vaporization modules 106, which can include one or more vaporization chambers, and render at least a portion thereof in the gaseous phase.

Stage 105 can comprise a vaporization subsystem wherein a portion or substantially all of the formation analyte is rendered from a liquid phase to a gas phase. Changing the state of the analyte, or a portion thereof, may be effected by changing one or more conditions to effect a phase transition from the liquid state to the gaseous state. 106 that may be utilized in some aspects of the invention to effect a change of state of the analyte. Module 106 may be implemented in the micro-scale, but may also be a meso-scale or larger assembly. As used herein, micro-scale refers to structures, assemblies, or components having at least one relevant dimension that is in a range of approximately 50 nanometers to one millimeter. The recitation of micro-scale measurements in the present application is not intended to be limiting in scope, as the present invention may be practiced on a variety of scales including but not limited to the aforementioned micro-scale.

A portion of the vaporization chamber 106 can be filled with a sorbent material, such as a carbon-based molecular sieve material. The sorbent material typically delays the progress of heavier components to the entrance of the column during the brief period, approximately one second, during which the column is charged with the sample. The sorbed components can be subsequently expelled during the much longer time, e.g., much greater than one second, during which the content of the vaporization chamber is flushed.

In preferred embodiments of the invention, the structure can be comprised of a thermally conductive material that facilitates heat transfer to the bulk of the vaporizing sample. Further preferred structures can serve as a trap or filter that removes, for example, any non-vaporizable components, such as but not limited to, asphaltenes and sand, entrained in the sample. A non-limiting example of such a material is silica glass wool. The invention, however, is not limited to structures having a randomly porous nature and facilitates phase transition and dispersion and mixing of the sample with a carrier gas may be utilized in one or more embodiments. For example, baffles and fins may be utilized in place of or in conjunction with glass wool.

Heating during vaporization of the analyte can be performed to any suitable or desired temperature and/or in accordance to a predetermined heating profile or temperature program. For example, the temperature of at least a portion or section of chamber 106 can be raised to a first vaporization temperature and held for a first period. The temperature of the same or different section of chamber 106 can then be raised, or lowered, to a second vaporization temperature and held or maintained for a second period. Further variations of such a heating scheme can incorporate additional ramping and staging steps. Indeed, variations of the heating scheme that can be utilized implicate those that have adjustable rates of heating and/or durations of soaking or holding at a particular temperature. As discussed below, various stage vaporization processes can advantageously be utilized to fractionate the analyte in the handling stage and thereby facilitate the rapid analysis.

At least a portion of the vaporized analyte can then be carried in a mobile phase by disposing at least a portion thereof in a carrier gas from, for example, a carrier source 107 of helium gas. The mobile phase is typically introduced into the first analytical stage 110 into a first stationary phase including first chromatographic column 130. Depending on the affinity between the components of the analyte and the stationary phase, the lighter or lower molecular weight compounds elute before the heavier compounds. The first eluting portion from first stage 110 can then be introduced into a second analytical stage 120 for further separation. In some embodiments of the invention, a portion of the analyte from the first stage, such as the later eluting, heavier molecular weight components, are optionally diverted to a detector for quantification (is there a number for the detector in the figure).

In some cases, at least a portion of the vaporized analyte is directed in stage 110. First column 130 can comprise, for example, a relatively fast chromatographic column by, for example, selecting the matrix to have a lower affinity for hydrocarbon compounds. A non-limiting example of a fast column is an about 10 m long with an about 0.18 mm internal diameter column and about a 2 μm thick dimethyl polysiloxane stationary phase. The column can be operated at any desirable temperature that provides a suitable separation spread of at least one component relative to another component. For example, the initial column temperature is designed to be at the maximum tool operating temperature of about 200° C. Further, the rate of the mobile phase progressing through first column 130 can also be at a desirable flow rate that provides the suitable separation effect. For example, the carrier phase can utilize helium carrier gas at a flow rate of greater than about 0.3 cc/min in accordance with one embodiment of the present invention.

In one embodiment, he first or early eluting portion of the eluent from first column can be characterized as constituting primary gases and light hydrocarbon compounds that are not separated or affected by the first column stationary phase. These components can be introduced into one or more alternative separation stages or directed to one or more detectors for quantification. A valve 140 can be utilized to direct the first eluent from column 130 into the subsequent separation stage 120 or to a detector 180. Although valve 140 is illustrated as a component of stage 110, it can be associated with second stage 120 or another unit operation. Likewise, detector 180 need not be considered as a component of stage 110.

As shown, a second separation stage 120 can comprise a second chromatographic column that can separate the permanent gases and light hydrocarbons not separated in the first column. At least a portion of second chromatographic column 160 can be a divinylbenzene porous layer open tubular (PLOT) column. A non-limiting embodiment of second column 160 can be an about 15 m long having an about 0.32 mm inside diameter tubular column. Polarity characteristics of the stationary phase of the column can be adjusted to provide a desirable or suitable degree of separation of at least a portion of the components.

In accordance with one operational embodiment of the invention, after the components of interest have entered second column 160, switching valve 140 can change position so that components having longer retention times do not enter the second column. Rotary, sliding, needle, or diaphragm valves are all suitable for this application. The timing of this switching operation can be predetermined, by determining the elution time of the components of interest in, for example, one or more calibrating operations, or be adaptive, by concurrently monitoring the output from the first column. FIGS. 1A and 1B exemplarily illustrate these arrangements; in FIG. 1A, switching valve is actuated by a controller (not shown) during a calibration run and in FIG. 1B, a non-destructive detector 180 can be disposed to receive at least a portion of the first eluent from column 130 prior to being introduced into switching valve 140 and subsequently separated in second column 160. Non-limiting examples of non-destructive detectors that may be implemented include systems and techniques that determine the thermal conductivity of the eluting stream, and/or systems that techniques that utilize optical behavior of the as-eluting stream. For example, a composite thermal conductivity of the eluting stream can be measured and if the measured thermal conductivity exhibits a pattern of insufficient separation, then switching valve 140 can be actuated to direct the eluent stream to the next stage or to discharge.

In accordance with some embodiments of the invention, after the valve is switched, carrier gas may be directed to flow through both columns. The output of the first column can be further monitored while clean carrier gas may be introduced through the second column. The temperatures and carrier gas flow rates in each column can be separately varied according to one or more predetermined programs or schedules. In some cases, the flow rate direction of the eluent or carrier phase can be reversed and/or heat applied to facilitate purging the column before the sample components have transited.

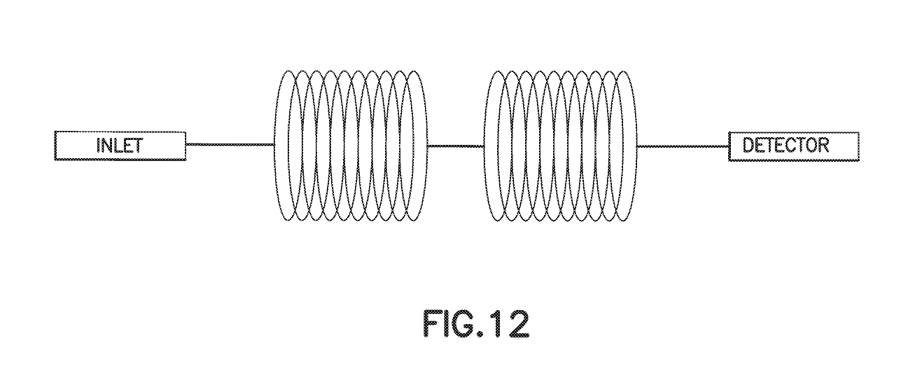

A configuration of a dual column ensemble in some embodiments of the invention can utilize two or more columns connected in series as schematically shown in FIG. 12. The columns can have either differing phase volume ratios or can be coated with different stationary phases. This simple configuration can advantageously avoid valves or flow switching devices and relieves the instrument of the need for midpoint detection and may only require direct fluidic connection from the first column to the second and temperature programming of both columns. Enhanced separation of the sample relies on the differing analyte interactions of each species in each column, with retention being governed by the stationary phase characteristics (thickness and structure) and the temperature of the column during the residence time of each species in that column.

The preferred embodiment of this architecture typically utilizes thin film wall coated open tubular columns (WCOT) as the first column with a variety of second columns, including, for example, thick film WCOTs, porous layer open tubular columns (PLOT), or packed columns. The first column can be at a lower temperature in the temperature programming ramp when sample injection occurs. Two scenarios may be considered. First, the lighter molecular weight components, e.g., those having lower boiling points, will propagate down the WCOT column because of minimal retention on this first stationary phase. Second, the heavier molecular weight components may on-column focus at the inlet of the first column and will typically be retained in the stationary phase. The lighter components, will typically travel through the first column at the rate of the carrier gas velocity until the reach they second column, the PLOT or the packed column. Such components can thus enter the second column at the beginning of the temperature programming ramp. The lower temperature will allow for better separation of the lighter components and heavier components can gradually desorbed from the stationary phase as the temperature program begins to heat the column. The separation on the first column will proceed as a normal temperature programmed GC analysis. An important aspect of making the column configuration work is that it may be necessary for the second column to be at highest temperatures when the heavy molecular weight components begin to elute from the first column. Retention of these molecules on the second column can significantly degrade the separation achieved on the first column.

Further embodiments of the invention may utilize Deans switch as subsystems, instead of or in conjunction with valves, to facilitate direction of the various streams of the system. For example, a portion of the effluent stream from one chromatographic column into a second column can be directed utilizing conventional valve assemblies or Deans assemblies as disclosed by Deans, D. R. in, for example, the Journal of Chromatography, 1981, 203, 19-28 and Dunn et al., in the Journal of Chromatography A, 2006, 1130, 122-129.

The second column usually has a stationary phase of differing characteristics, either film thickness or functionality. Typically there is a detector at the end of the first column and flow from goes directly from the column to the detector. By diverting the flow at predetermined time ranges, effluent from the first column flows directly into a second separation column. The second analysis can be performed to enhance the separation of components that co-eluted from the first column. The Deans switch is compatible for column configurations including wall coated open tubular columns, porous layer open tubular columns and packed columns.

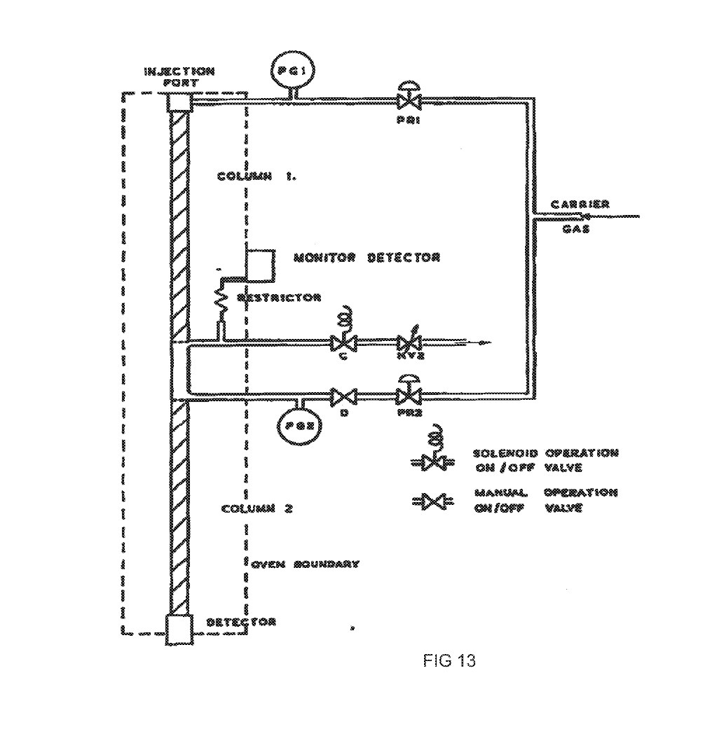

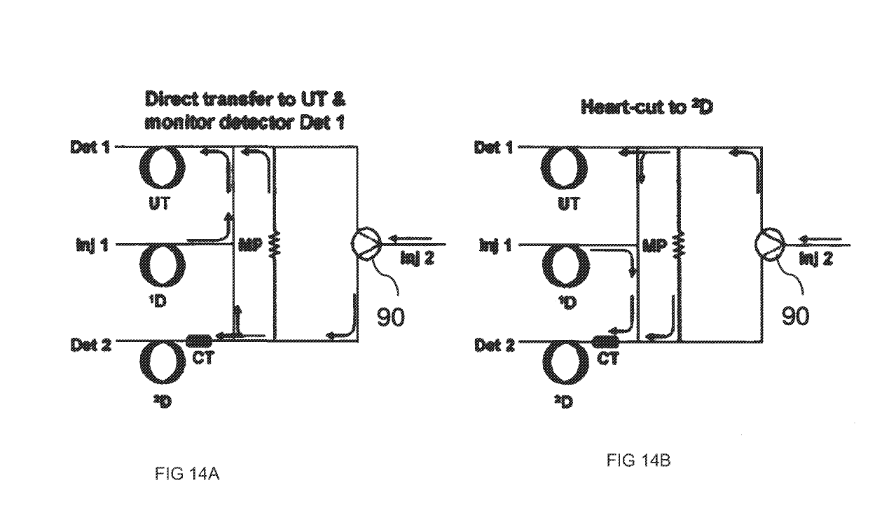

The switching valve guides the first column effluent either through a pneumatic restrictor to a detector, or through a second column. Activation of the switch relies on a pressure balance achieved at the midpoint as schematically illustrated in FIGS. 13 and 14A and 14B.

Referring to FIG. 14A, when the solenoid valve 90 is in the downward position, flow from the first separation column ¹D is diverted to a pressure restriction UT to a detector Det1. When the solenoid valve 90 is flipped to an alternative position, shown in FIG. 14B, the flow path is redirected, and flow from first column ¹D is directed to a second separation column ²D. Valve 90 can be actuated to remain in this position for a predetermined period of time before switching back to the alternate flow path. By diverting the first column effluent, the second column can be used to resolve peaks that are not separated by the first column separation. The Deans switch can be used either a single time during the analysis, or to inject multiple cuts of the first column effluent.

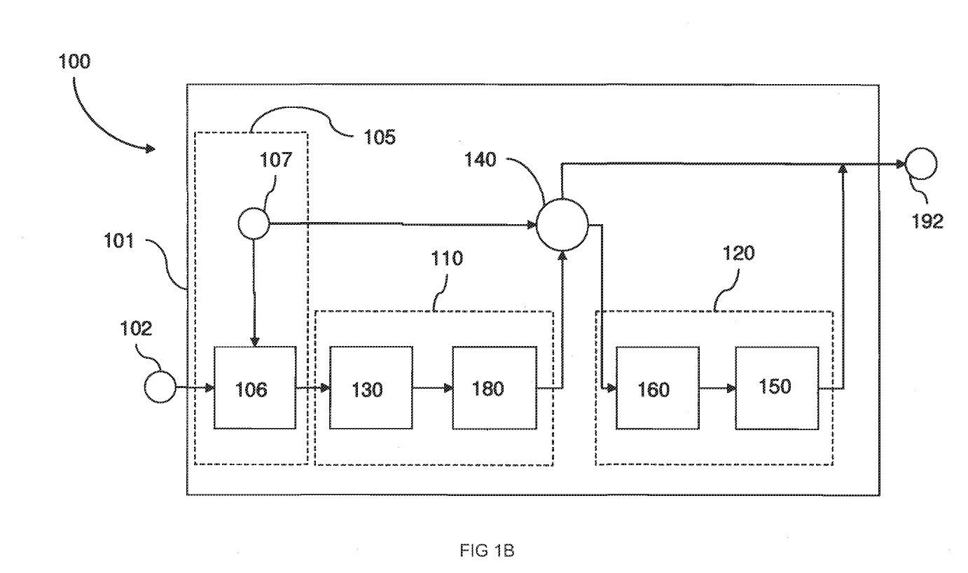

Temperature programs, flow rate programs, and reversing the flow rate direction can also be implemented using only one chromatographic column in a downhole environment. All exiting eluting and analyzed streams can then be directed to a waste collecting unit 192 wherein it can be stored until discharged in a surface facility. Although waste unit 192 is illustrated as being disposed outside of housing 101, some embodiments of the invention contemplate housing configurations containing one or more waste collection units. Waste collection unit can comprise one or more vessels disposed to accumulate waste gases during downhole operation of the system. Further aspects of the invention involve parallel and/or sequential chromatographic separation techniques. In the parallel/sequential implementation of the invention exemplarily illustrated in FIG. 2A, analyte from a source 102 can be introduced into a vaporization module 106. The conditions of the vaporization module 106 or a chamber thereof can be varied such that at least a portion of the sample can be vaporized. Controlled vaporization can be achieved by, for example, raising the temperature and/or lowering pressure, conjunctively or independently. The vaporized portion can be directed for separation into and through a first chromatographic column 311 and the resulting eluent thereof can be analyzed or quantified in a first detector (not shown). The conditions of the vaporization chamber can be further modified by, for example, raising the temperature and/or reducing the pressure of vaporization chamber to promote further vaporization of the analyte and provide a second vaporized portion. The second vaporized portion of the analyte can be carried in a carrier gas and directed into and through a second chromatographic column 312 to facilitate separation of the components. The corresponding eluent thereof can be analyzed and quantified by the same detector utilized in characterizing the first column eluent or a second detector (also not shown). In some cases, a third vaporization schedule can be implemented in an analogous manner described with respect to the first and second controlled vaporization processes.

Further variations of the analytical and separation schemes are contemplated. For example, the temperatures and carrier gas flow rates used for each column can be separately varied according to predetermined programs. The flow rate direction in any column can be reversed to purge that column before all components have transited. Moreover, any fraction can be purged instead of being sent to a chromatography column. Although, this implementation advantageously requires a single gas inlet of carrier gas to each column, a plurality of carrier sources may be utilized. The parallel/sequential technique may allow utilizing a reduced number of chromatographic columns relative to the number of vaporization increments. For example, the third vaporization protocol may be utilized to further or even fully vaporize the analyte and, instead of directing the final vaporized portion into a third chromatographic train, including at least one chromatographic column and a detector, it can be directed to one of the earlier chromatographic trains for characterization. Flow control valves (not shown) disposed between the chromatographic columns and module 106 can respectively be actuated to selectively allow flow from the module into the column in the desired sequence.

FIG. 2B exemplarily illustrates still further aspects of the invention pertinent to parallel/simultaneous analysis. Analyte can be introduced from source 102 into a vaporization chamber of module 106. One or more conditions of at least a portion of the vaporization chamber, such as the temperature and/or pressure, can be controlled or otherwise regulated according to a predetermined schedule or be adaptive in response to one or more measured attributes of the analyte. For example, a part of the sample can be vaporized at low temperature and directed into a first chromatographic column 311 with a carrier gas from a primary carrier source 107. Once the vaporized portion, or at least a part thereof, is transferred for separation and analysis in the first chromatographic train including column 311, a valve (not shown) can isolate module 106. Optionally, a secondary source of carrier gas 107a can be utilized to carry the first vaporized portion through the first chromatographic train and a first detector (not shown) for characterization. While the first part of the sample is analyzed in the first train, the conditions of the vaporization chamber can be modified in a predetermined, or alternatively, in a derived, manner to provide a second vaporized portion of the sample, typically at a second, higher temperature, and/or at a lower pressure. The second vaporized portion can be carried into a second chromatographic train including, for example, a second chromatographic column 312 utilizing carrier gas from source 107 and/or source 107b. Valves (not shown) can isolate the primary source of carrier gas and a secondary source of carrier gas can be utilized to further carry the second portion of the sample through second column 312 and, optionally, to a second detector (not shown) for characterization. In an alternative vaporization schedule, the vaporization chamber pressure can be varied instead of or in addition to varying the temperature. Further embodiments may involve vaporizing the analyte to provide a third vaporized portion for analysis in a third chromatographic train including column 313. In analogous manner, the third vaporized portion may be carried utilizing a carrier phase from source 107 and/or alternative source 107c.

Further embodiments of the invention contemplate utilizing one or more pre-concentrator assemblies between the vaporization chamber and one or more of the column to focus the analytes introduced into the column. Moreover, the temperatures and carrier gas flow rates in each column can be separately varied according to predetermined programs. The flow rate direction can also be reversed and/or heat applied to facilitate purging any of the columns, even before all sample components have transited therethrough. In some cases, any fraction of the sample can be advantageously purged instead of being sent to a chromatography column. Further variations include the use of one or more additional columns in one or more chromatographic separation and analysis trains.

The simultaneous implementation illustrated in FIG. 2B can also be realized by performing a series of injections, each at a different vaporization chamber, into a single column. The temperature of the vaporization chamber can be varied. For example, a part of the sample vaporized at low temperature is carried into a chromatographic column with a primary source of carrier gas. Thereafter, the primary source of carrier gas is isolated and a secondary source of carrier gas is introduced to mobilize the first part of the sample through the column to a detector. While the first part of the sample is traversing the column, the temperature of the module is increased. The part of the sample vaporized at a second temperature is carried into the same chromatographic column at a later time. Preferably, the analysis time period is less than the time period between injections. 2B Otherwise injection delay may be employed to separate the chromatograms from subsequent injections. The vaporization chamber pressure can be varied instead of or in addition to varying the temperature. A pre-concentrator assembly can be utilized between the vaporization chamber and each chromatographic column to focus the injection of analytes into the column. The temperatures and carrier gas flow rates in each column can also be individually varied according to one or more predetermined programs.

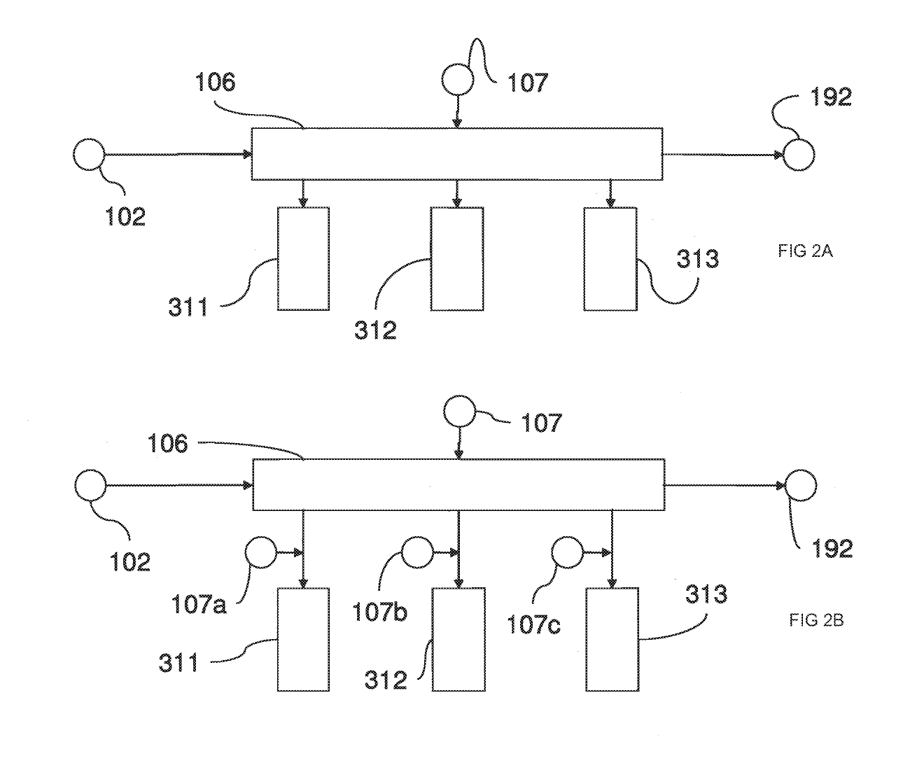

In another embodiment of the invention, illustrated in FIG. 3, a set of filters may be utilized to selectively allow a particular range of components into a particular column, which is optimized for that range of components. The filters can comprise membranes, sorbents, or zeolites. For example, a portion of vaporized sample from chamber 106 can be vaporized in accordance with any of the above-described schemes and directed into a first chromatographic column 410 of a first train by way of a filter 411. Filter 411 can comprise, for example, adsorbent material that selectively permits permanent gases, such as methane and ethane, to pass therethrough while trapping other hydrocarbon compounds. A first detector 451 can then be utilized to analyze and quantify at least a portion of the eluent from the first train. A second chromatographic train including one or more second columns 420 and a second detector 452 can be utilized to separate, analyze, and quantify a second portion of the sample vaporized in chamber 106. A second filter 412 can be disposed to selectively permit lower molecular weight hydrocarbons, such as propane, butane, and pentane, as well as isomers thereof, and other hydrocarbon compounds having between three to five carbon atoms, into the second train and characterized by way of second detector 452. Additional chromatographic trains are illustrated showing associated filters 413 and 414 respectively disposed upstream of chromatographic columns 430 and 440. Respective eluent streams from each column can be characterized in dedicated detectors 453 and 454 or in one or more of detectors 451 and 452. Advantageously, filters 413 and 414 can be comprised of adsorbent material as described above that, respectively, allow intermediate weight hydrocarbon compounds, e.g., having between six to fifteen carbon atoms (C₆ to C₁₅), or heavier hydrocarbons, having greater than fifteen carbon atoms (C₁₅₊). Thus, the various embodiments of the invention contemplate multiple serial columns and/or multiple columns in parallel.

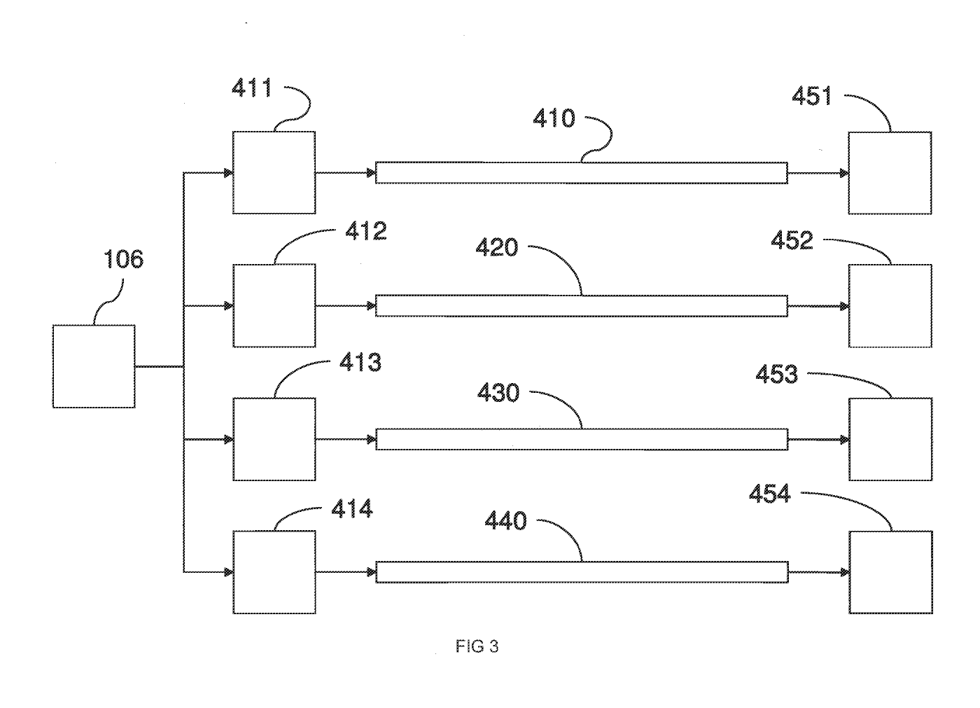

In some advantageous embodiments of the invention, analytes can be separated and characterized without the use of chromatographic columns. As with any of the information obtainable from the various other embodiments described herein, the measured data can be used to provide an equation of state model. FIG. 4 schematically illustrates an analytical system 500 in accordance with this aspect of the invention. Analytical system 500 can have a housing 101 encasing substantially all components of the system to facilitate downhole placement thereof. In service, analytical system 500 is typically fluidly connected to one or more sources 102 of an analyte, such as formation fluid, typically through a tool flowline. System 500 can further comprise one or more vaporization modules 106 capable of providing one or more vaporizing conditions of the sample in accordance with any one of the embodiments disclosed herein. For example, module 106 can be implemented utilizing one or more of the sequential or simultaneous vaporization techniques as substantially described with respect to FIGS. 2A, 2B and 4. In any of the embodiments, vaporization of the analyte can be controlled by, for example, adjusting one or both of the sample temperature and pressure, to selectively vaporize one or more particular components. For example, the sample can be heated to a first temperature and/or the pressure thereof reduced to induce vaporization of substantially only permanent gases, which are then directed to a detector 150, also contained within housing 101. This set of conditions can be maintained for a suitable period until substantially all of such components have been carried by a carrier gas, from source 107, into detector 150 for quantification. Waste gas from detector 150, or module 106, can be collected in one or more accumulation units 192. Subsequently, one or more conditions of module 106 can be varied to induce vaporization of one or more higher boiling point components. For example the temperature of the sample and/or the pressure exerted thereon can be raised and lowered, respectively, to vaporize the next component or set of components. The particular temperature and pressure conditions can be determined by calibration in a laboratory setting or in situ. The above described stepwise incremental vaporization procedure can be utilized until the components of the sample have been satisfactorily characterized.

To minimize the time interval during which the sample is introduced into a column, one or more valves can be used to control the flow of carrier gas through the vaporization chamber thereby allowing the vaporized sample to split into multiple streams, each of which may be processed sequentially or simultaneously, or exhausted from the apparatus in an analogous manner as described with respect to FIGS. 2A and 2B. For example, a first amount of the sample injected into the vaporization chamber can be introduced into any one column for analysis. In the preferred embodiment, the flow of carrier gas through the vaporization chamber introduces the sample into a column in a relatively short time, e.g., less than about one second, to ensure sharp peaks, maximize vaporization, and prevent overloading the columns.

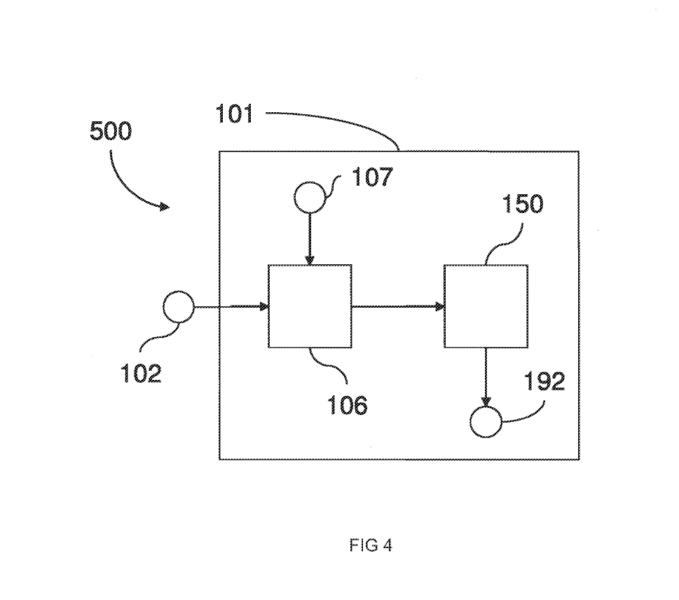

During handling in preparation for characterization, the sample can be slowly expanded and agitated to prevent supersaturation. For example, the rate of volumetric expansion of the sample can be regulated, linearly with respect to time or otherwise. Below the bubble or dew point the sample is typically in two distinct phases. One or both of the phases can be sampled at various pressures in the downhole environment and evaluated with the downhole chromatographic systems and techniques of the invention. FIG. 5 illustrates an embodiment of the invention involving a vaporization module 106 utilizing at least one variable-volume vaporization chamber. In module 106, an analyte sample from a source 102 can be introduced into a primary vaporization chamber 630 which is fluidly connectable to an ancillary expansion chamber or pocket 631. The effective total volume of chamber 630 and pocket 631 can be modified by regulating or actuating piston assembly 633. The vaporized fraction of the sample can then be directed and characterized in a detector 180. Carrier gas from one or more sources 107 and 107a can be used to facilitate transfer of the vaporized fractions through the system and eventually into a waste collection unit 192 during and/or after characterization. Subsequent portions of the sample can then be vaporized by further manipulation of assembly 633 to change the effective expansion volume. In similar manner, the second vaporized portion can be characterized in detector 180 or other detectors (not shown). Of course, further portions can be vaporized and characterized as desired.

Actuation of piston 633 can be effected by, for example, mechanical, electromechanical, hydraulic, or pneumatic assemblies. One or more controllers can be used to regulate the actuation and the heating rates according to a schedule and provide the desired incremental fractionation and vaporization. Alternatively, or in conjunction, one or more ancillary, typically non-destructive, detectors (not shown) can be disposed downstream of the vaporizing chamber to monitor at least one property of the fractionally vaporized portion and be used to provide an indication of an end of a fractionation step. For example, the thermal conductivity of the carrier gas, having the vaporized portion entrained therein, can be monitored. If the measured thermal conductivity approaches or is within a tolerance level of a value that represents essentially only carrier gas, then no further entrainment can be assumed which indicates an end of the current fractionation step. The next set of fractionation conditions can then be applied and the resultant vaporized portion be characterized.

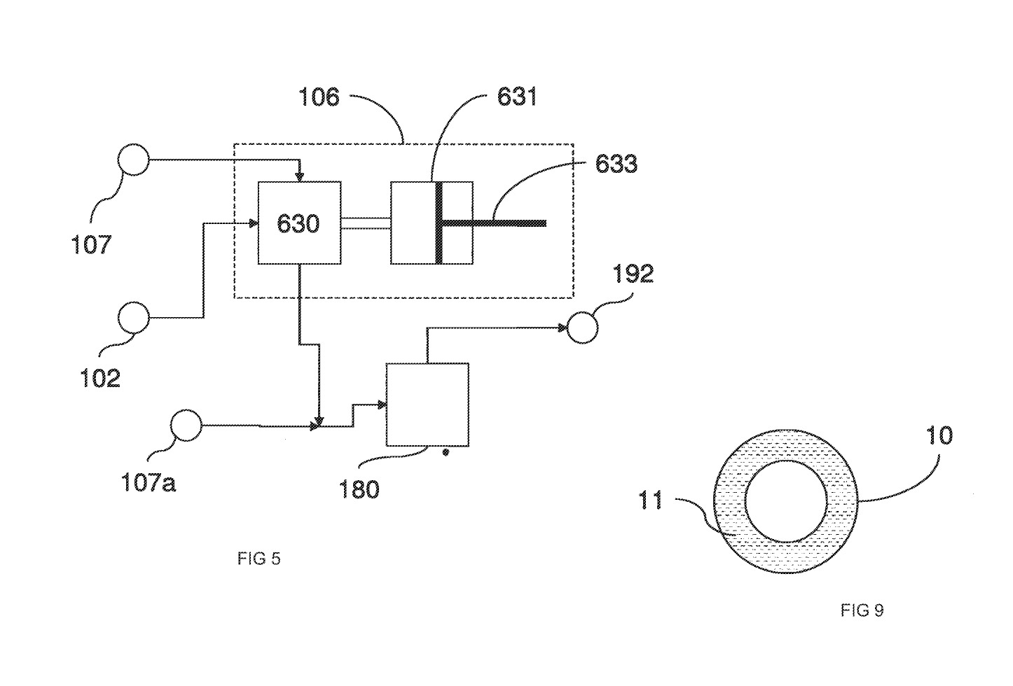

An alternative embodiment is illustrated in FIG. 6 which shows fractional vaporization performed in a plurality of vaporization chambers 711, 712, and 713, each receiving a sample to be analyzed from source 102. Each of chambers 711, 712, and 713 can be at different conditions thereby promoting vaporization and consequently, fractionation to a certain level. For example, chamber 711 can be heated to a first temperature and the pressure therein reduced so that a first portion of the sample contained therein is vaporized. Chamber 712 can be heated to a second temperature, e.g., higher than the temperature and at or lesser pressure that the pressure in chamber 711. Likewise the imposed conditions on chamber 713 can be at a higher temperature and lower pressure than chambers 711 and/or 712. The various applied conditions thus provide a plurality of vaporized samples for separation in one or more chromatographic columns 731, 732, and 733. Preferably, the respective stationary phases in the columns are tailored to selectively separate the correspondingly introduced vaporized portions for quantification in one or more detectors 781, 782, and 783.

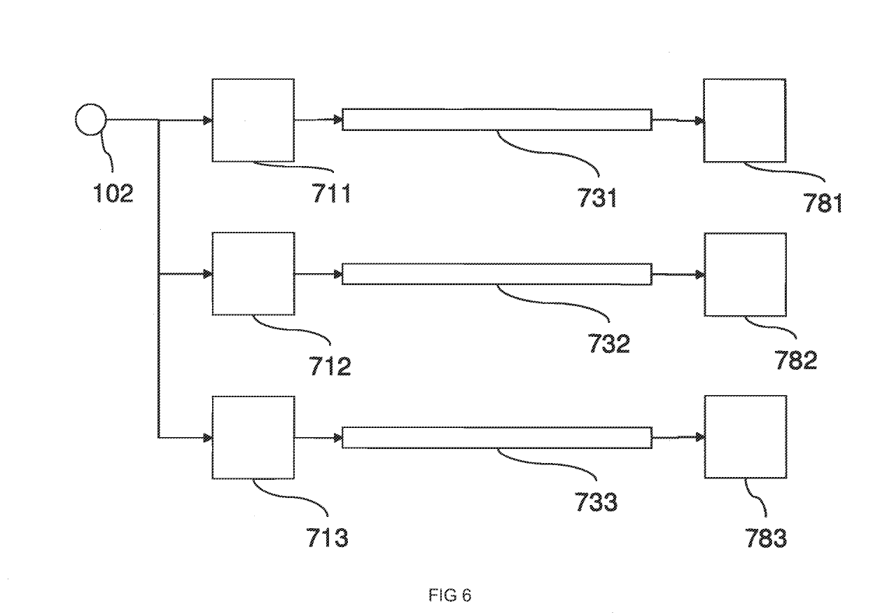

A further alternative embodiment is illustrated in FIG. 7 in which sample from source 102 is sequentially vaporized in a serial arrangement of vaporization chambers 811, 812, and 813. Fractional vaporization of the sample can be effected by serially introducing the sample into chamber having progressively different conditions of vaporization. For example, first chamber 811 can be at a first temperature and/or pressure which allow vaporization of a portion of the sample. The vaporized portion is then separated and characterized in a first chromatographic train comprising first column 831 and detector 881. The remaining condensed portion of the sample is then transferred into chamber 812 wherein a second portion is vaporized and analogously separated and characterized in a second chromatographic train comprising second column 832 and second detector 883. Optionally, fractional vaporization of the sample can be further performed in subsequent chambers and the vapor therefrom characterized in subsequent chromatographic trains.

Thus, the invention may be used in any remote environment to analyze mixtures with a wide range of boiling points, such as in a subsurface, subsea, or outer space environments.

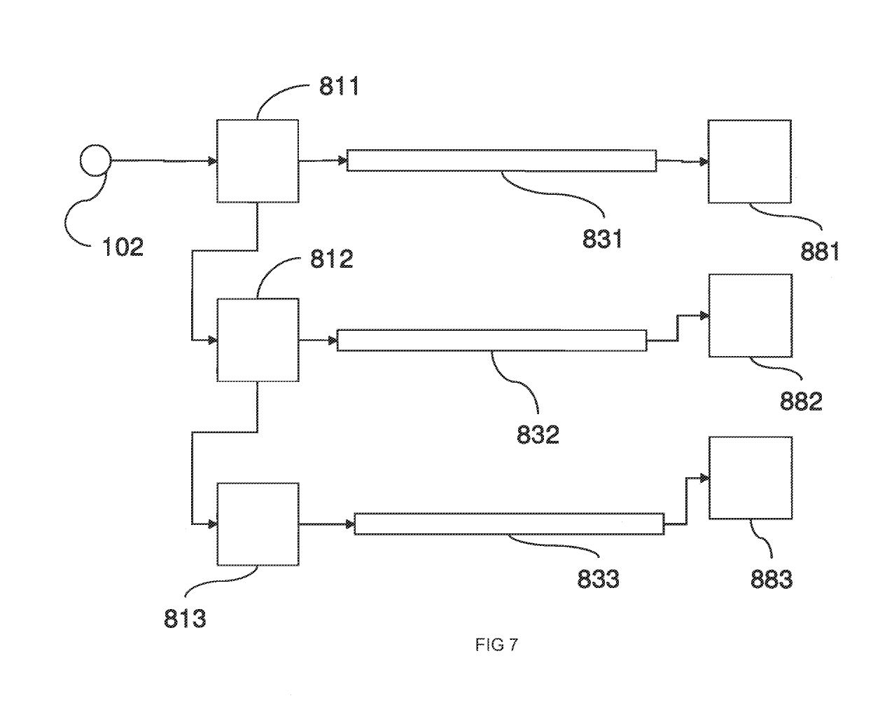

Further aspects of the invention relate to systems and techniques that focus or sharpen a profile of an eluting component. Typically, components in a mixture are separated in a chromatographic column. However, depending on the affinity of the mobile phase and the relative retentive attributes of the stationary phase, a component typically broadens during elution. The broadening phenomena, however, can increase the periods for subsequent separation and/or quantification operations. Some aspects of the invention involve one or more modulators that can trap or capture at least a portion of one or more broadened eluting components. Substantially all or at least a desired fraction of the one or more trapped components can then be controllably released for further separation and/or characterization in one or more chromatographic trains. FIG. 8 shows an analytical system 900 comprising a housing containing at least one vaporization module 120 disposed to receive an analyte sample from a source 102. A source 107 of carrier gas is fluidly connectable to module 106 to entrain at least a portion of vaporized sample in a mobile phase. Also in housing 101 is a first chromatographic column 130 comprising a stationary phase into which the mobile phase from module 120 is introduced. Column 130 facilitates separation of the component of the vaporized sample into a first eluting stream which typically has at least one component temporally separated with a broad eluting profile. The at least one eluted component can then be characterized in a detector or introduced into at least one modulator 145 that captures and retains at least a desired fraction of the at least one broadened component. The one or more captured components can then be rapidly released from modulator 145 into a second mobile phase and introduced into a second chromatographic train comprising a second column 160 and a detector 150 for further separation and characterization. Any waste stream from the first and/or second separation operations can be contained in unit 192.

The modulator typically utilizes thermal cycling to capture, focus, and reinject effluent as it leaves the first column. In some cases, one or more chemical adsorbents or absorbents can be housed within the modulator to aid in this process.

The adsorbent or absorbent material traps the analyte components to be modulated within a narrow band on a surface or within a volume that is in direct contact with the stream of eluent flow. The use of an adsorbent or absorbent exploits the fundamental phenomenon of partitioning into stationary phase, also known as β focusing that occurs when the leading edge of a solute band is slow relative to the trailing edge because of a large gradient in the equilibrium capacity factor with distance. Maximum band sharpening occurs when the analyte has a strong affinity towards and is trapped in the minimal volume of stationary phase.

Chemical modulation with the use of adsorbent or absorbents can be attained in many possible configurations. No constraints on the design, configuration, or number of adsorbent/absorbents are imposed by the current invention. To provide chemical modulation, an analyte stream typically comes into contact with an adsorbent material. The analyte components of the stream are trapped on or in the adsorbent/absorbent, while carrier gas continuously flows. After a determined period of time in which the analyte is focused on the stationary phase, the analyte is desorbed and is released as a narrow concentration pulse in a mobile carrier gas phase.

The adsorbent and/or absorbent used as a modulation stationary phase can be designed in any geometrical configuration. Non-limiting examples of such configurations include channels, tubes, beds, linings, coatings, membranes, porous media, traps, filters, flat surfaces, micro-surfaces, MEMS-surfaces, MEMS-channels, nano-surfaces, nano-volumes, nano-particles, nano-channels, and/or carbon nano-tubes.

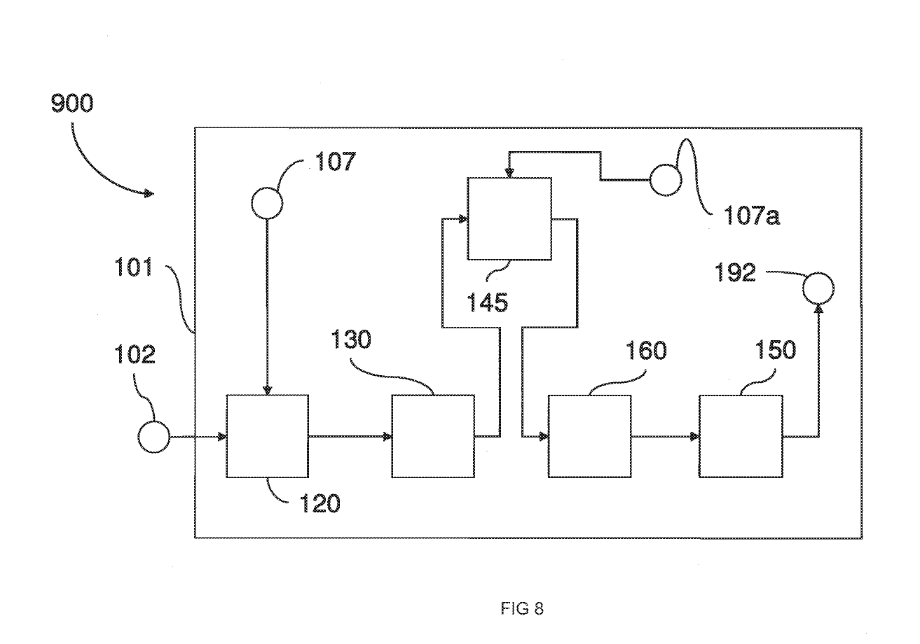

FIG. 9 is a schematic illustration showing a cross-sectional view of a tubular chemical modulator 10 containing adsorbent matrix 11 in accordance with some embodiments of the invention. As carrier gas flows within the tubular modulator, the components are trapped in the matrix of the stationary phase matrix 11. Any type of material can be used as the stationary phase in the modulator, including, for example, molecular sieve materials, diatomaceous earth, porous polymers, and polar/non-polar liquid stationary phases, cross-linked phases, gums, carbon nano-tubes, nano-spheres, and/or porous carbon.

The contact between the eluent stream and the stationary phase can occur by any type of flow, including flow through porous media, packed beds, channels, coated open tubes, packed tubes, coated or packed micro-tubes, micro-channels, and capillaries. Flow may also occur across surfaces and around objects, micro-particles, and nano-particles. The flow fields may be characterized as Poiseuille capillary flow, laminar flow, turbulent flow, transition flow, helical flow, and etc. The flow of the carrier gas may change directions, sources, or chemical species/composition during the focusing/regeneration process. For example, the adsorption may be back-flushed with the same or different mobile phase carrier gas species that was used as the carrier gas in the primary analysis column.

De-sorption or release of the analyte into the mobile phase as sharp a concentration pulse can be performed by a variety of different techniques, including, for example, heating, solvent stripping, pressure programming, carrier gas flow programming or composition alteration. Radiation exposure as well as magnetic or electrical fields or currents, or chemical reactions may also be used in specialized applications to trigger release of the trapped components.

By controlling analyte trapping and de-sorption, modulation provides periodic release of sharp analyte concentration pulses into the second column of a comprehensive multi-dimensional gas chromatography analysis system. The modulation frequency may be modeled, controlled, and optimized by considering factors such as carrier gas flow, analyte concentration, adsorbent/absorbent capacity, analyte/stationary phase affinities, analyte volatility, thermal management, and etc. In addition, a solvent may be added to the carrier gas during or before modulation to assist in analyte focusing during analyte trapping or de-sorption by exploiting the phenomenon of solvent focusing. Focusing can also be further enhanced, in some cases, by increasing the temperature in at least a portion of the modulator to facilitate de-sorption by, it is believed, evaporation from the stationary phase.

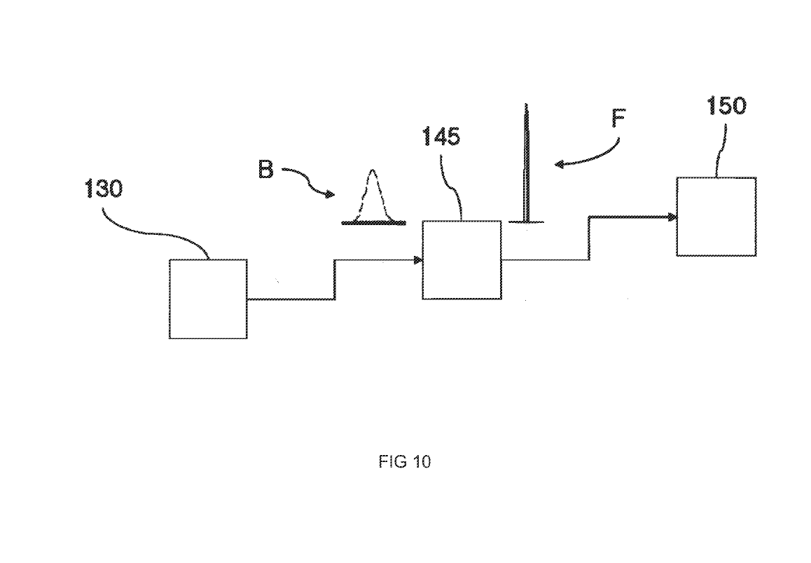

Still further aspects of the invention pertain to modulation system and techniques that can be applied in multi-dimensional gas chromatography systems that do not involve comprehensive modulation. For example, one or more chemical modulators of the invention can be used as effective heart cutting modulators, in which a certain unresolved or under-resolved peak or fraction of an eluent from a primary analysis column is retained and focused on a stationary phase for subsequent de-sorption and analysis on a secondary chromatographic column for improved resolution. Other multiple column analysis systems and methods can include selective secondary column analysis, wherein certain analyte classes are routed to a second column for enhanced separation, as well as selective partial modulation, wherein only certain classes of analytes are modulated for improved resolution. FIG. 10 illustrates the functional use of a chemical modulator 145 of the invention which, in at least one sense, transforms a broad peak B of a component of an eluent stream from a first chromatographic column 130 into a sharp peak F for injection into a second chromatographic column 150 to facilitate an overall reduction in characterization time, compared to introducing the broadened, non-focused eluent stream.

Further aspects pertinent to modulation systems and techniques of the invention are described. In one embodiment, a single adsorbent bed is in thermal contact with a heater. The primary column effluent is collected onto the adsorbent bed during focusing. At least a portion of the bed is heated for rapid de-sorption of the captured portion of the analyte. Typically, the bed is in fluid communication, for at least a period of time, with the primary and secondary columns by means of tubing or other flow channels. Back-flush valving assemblies and techniques can also facilitate de-sorption and improve the resolution of the desorbed components.

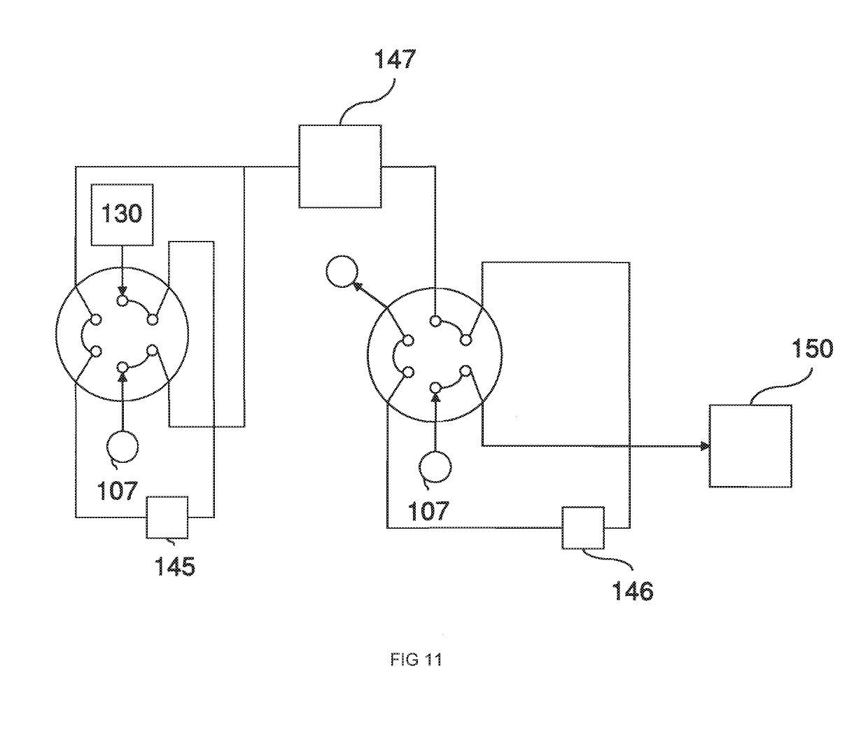

An alternative embodiment of the modulator, schematically illustrated in FIG. 11, can comprise a plurality of multi-staged adsorbent beds 145 and 146 arranged in series associated with corresponding back-flushing valves 155 and 156 To minimize the total vapor concentration band-width eluting from the adsorbent bed during the regeneration cycle, the each of the multi-staged adsorbent beds 145 and 146 can be designed with a plurality of stages to capture various volatile fractions of components during loading. Typical carbon-based molecular sieves can be used as adsorbents with target a specific range of component vapor pressures. For example, carbon-based molecular sieve such as CARBOPACK™ and CARBOXEN™ material available for Supelco, Bellefonte, Pa., can be used. The adsorbent materials with the highest surface area per unit mass can target analyte components with the highest volatility. A staged design of the adsorbent bed can be used so that components with the lowest volatility have none or at least reduced contact with the adsorbents with the highest specific surface area. This can advantageously avoid utilizing higher de-sorption temperatures because it would reduce the likelihood of adsorption of low-volatility components in the high specific surface area adsorbent portions. To reduce contact between the lowest volatility components and the high specific surface area adsorbent material, the staged adsorption beds can be back-flushed and heated during the regeneration cycle. During the back-flushing cycle, components de-sorbed from their targeted material come into contact with only adsorbent of lower specific surface area. The combination of the back-flushing procedure along with the vapor-pressure targeting of components within the staged adsorption bed typically results in the band-width minimization of the eluted vapor.

The second embodiment can further comprise two or more sub-units including a collection adsorption sub-unit and an ejection sub-unit. In one configuration, a first sub-unit can have, for example, a 6-port sampling valve 155 with a multi-stage adsorption bed 145 incorporated within the sampling loop. A second sub-unit can similarly comprise a 6-port sampling valve 156 with at least one multi-stage adsorption bed 146. Alternative configurations may incorporate other mechanical flow systems for loading and regeneration of the multi-stage regeneration beds, without departing from the spirit of the currently disclosed invention. The present invention is not limited to a 6-port sampling valve configuration for mechanical loading and regeneration.

The collection adsorption sub-unit can periodically collect the majority of the eluent from the first column 130 into a first staged adsorbent bed 145, and, in some cases, periodically release the adsorbed components in a time-controlled manner, and, optionally, re-combine the released components with the first-column eluent during a regeneration stage.

The ejection sub-unit typically serves at least two primary purposes. Periodic collection into the second adsorption bed 146 of the combined vapor stream originating from both the regeneration of the first adsorption bed 145 and the eluent produced from the first column 130 during regeneration. Also, periodic release of the combined stream into the second column 150 in a single narrow concentration pulse.

The operation of the collection and ejection sampling sub-units can be time-coordinated such that loading and, in some cases, regeneration, occurs simultaneously on both sides. A delay loop 147 can be utilized between the two sub-units to prevent the de-sorbed components from the first regenerated bed from bypassing the second bed. The volume of the delay loop is typically designed to be slightly larger than the elution volume of the first analysis column in order to assure clean regeneration of the ejection sub-unit.

The importance of the ejection sub-unit in the modulation device can be demonstrated by considering the thermal processes which occur during the regeneration cycle. During the regeneration cycle, the temperature of the adsorbent bed is typically rapidly increased to a temperature where all known analytes of interest are desorbed and are back-flushed out of the bed by the reverse flow of carrier gas. Before the bed can be loaded with the next stream of eluent from the first column, the bed would typically be sufficiently purged of all analytes and subsequently cooled to a temperature where loading can occur. The heating-purging-cooling cycle takes a considerable length of time, during which the flow of eluent from the first analysis column would likely bypass the first adsorbent bed. Venting of the eluent flow during the regeneration cycle may result in the loss of a considerable amount of analyte and a large reduction in resolution.

In still another embodiment of a modulation device of the invention, a thick stationary phase of liquid adsorbent may be used to coat at least a portion of the inside wall of a capillary tube of short length. The capillary tube is typically in fluid communication with the first and second analysis columns. Preferably, the outside of the capillary tube is in the thermal contact with a rapid heater. During focusing phases, the eluent stream flows into the coated and collected in one or more capillary tubes; subsequently, the one or more capillary tubes are rapidly heated and the analyte components are released into a sharp, focused band in the mobile phase. The third embodiment of the modulator can serve as a direct replacement for thermal modulation devices which use cryogenically cooled capillary tubes for thermal focusing.

At least one differentiator of the disclosed chemical modulation system of the invention relative to current art modulators is the use of chemical adsorbents rather than manipulated temperature conditions or complex valving to provide the refocusing phenomena. The application of a chemical modulation system in the context of comprehensive two-dimensional gas chromatography analysis has many potential benefits over current art systems. Indeed, one of the most apparent advantages of a chemical modulation system of the invention avoids utilizing a source of cryogenic gas in to cool the modulator. As such, a chemical modulator can facilitate the application of multi-dimensional gas chromatography analysis in remote self-contained systems, without cryogenic gas management. In addition, no restriction is placed on the flow ratios of the first and second analysis columns, allowing for optimum flow velocities in both columns. Because the mobile phases are de-coupled between the analytical stages, the respective chromatographic columns can operate independently. Further, carrier gas in the second column is not required to originate from the first column. Additional advantageous features pertain to flexibly allowing use of different carrier gas types in the primary and secondary or additional columns for optimum resolution and/or analytical speed.

Additional features of the disclosed chemical modulator is the near or about 100% efficiency of transfer of analyte from the first analytical train to the second analytical train without slowing the carrier gas flow through the modulator or resorting to cryogenic temperatures. In contrast, current pulsed flow modulators do not fully modulate analyte peaks, while current art differential flow modulators do not provide 100% transfer efficiency. The various chemical modulation systems and techniques of the invention can provide the highest degree of confidence to the operator that important peak signals are retained and analyzed rather than being lost to vented effluent or noisy signals which cannot be de-convoluted.

Further enhancements may allow chemical modulation without a secondary column, for applications in, for example, calibration, “plus fraction” estimation of complex mixtures, selective quantification. Chemical modulation can be used independently of GC separation columns for class analysis quantification methods, boiling point fraction estimation, methods, and other methods.

The various columns discussed in the invention may be implemented as micofabricated gas chromatography columns. Thus, as MEMS columns, the invention can provide advantageous features compared to fused silica capillary columns. For example, MEMS columns can be fabricated having highly varied column geometries. Silicon etching techniques can be employed to create at least a portion of the channels, typically with rectangular cross sections. The height and width of such columns can be varied depending on the etch time and the mask designs that are used to create the channels. A notable advantage that MEMS columns offer over capillary columns is that high-aspect-ratio columns can be realized. In this scenario, one dimension is much larger than the other. For example, height can be an order of magnitude greater than the width. This flexibility in fabrication provides a relatively large cross section microfabricated channel with a narrow critical dimension. The large surface area can, further drastically increase the volume of the stationary phase contained within the column. Thus, the equivalent sample capacity of a wide bore capillary column can be realized at such small scales. Further, narrow width columns can provide a diffusion path length similar to that of a microbore column. Because the diffusion path length typically correlates to the number of interactions an analyte molecule will have with the stationary phase, providing a greater number of interactions, higher column resolution can be realized. The high-aspect-ratio microfabricated columns can thus compensate for the loss in sample capacity while still maintaining the high resolution of microbore capillary columns.

In addition, the increased cross sectional area of a high-aspect-ratio microfabricated column can reduce the pressure drop along the length of the column. With lower pressure drops, lower inlet pressures may be required thereby relieving pumping burdens. Alternatively, the overall column length can be increased, allowing for greater separation effect, without or at least not increasing stress on the rest of the system. Microfabricated columns can also utilize heaters and temperature sensors directly deposited onto the surface of the column. This configuration allows for at-column heating and rapid cooling of very low thermal mass columns. Where silicon is utilized as the substrate material, silicon, having a high thermal conductivity, thermal gradients across a column chip can be reduced to a minimum. Thus the invention contemplates utilizing other systems and techniques with or as alternatives to at-column heating of capillary columns using resistive heating of a metal sleeve disposed around the capillary column.

A further advantage of microfabricated columns pertains to resolution enhancement because monolithic systems detector dead volumes and connection line dead volumes can be minimized. It is the desired end result that band broadening in a microfabricated monolithic column be dominated by on-column contributions, allowing for maximum resolution.

Although various embodiments exemplarily shown have been described as using sensors, it should be appreciated that the invention is not so limited. Moreover, the invention contemplates the modification of existing facilities or systems to retrofit and implement the techniques of the invention. Thus, for example, an existing analytical facility can be modified to include one or more chromatographic systems in accordance with one or more embodiments exemplarily discussed herein. Alternatively or in conjunction therewith, existing chromatographic systems can be retrofitted or otherwise modified to perform any one or more acts of the invention.

A switching valve 140 can be used between the two columns 130 and 160 as shown in FIG. 1A. Early eluting components would be directed to from the first column to the second column 160 for further separation and characterization by way of the first detector 150 as described in the serial arrangement above. Once the early non-resolved components elute from the first column 130, after approximately 60 sec for the sample and conditions above, switching valve 140 diverts the flow of the first column 130 to a second detector 180. The inlet pressures may be different from the above runs to maintain the optimum or preferable flow rates in the columns for the different configurations.

Having now described some illustrative embodiments of the invention, it should be apparent to those skilled in the art that the foregoing is merely illustrative and not limiting, having been presented by way of example only.

Various alterations, modifications, and improvements can readily occur to those skilled in the art and such alterations, modifications, and improvements are intended to be part of the disclosure and within the scope of the invention. Although many of the examples presented herein involve specific combinations of method acts or system elements, it should be understood that those acts and those elements may be combined in other ways to accomplish the same objectives. For example, staged analytical systems and techniques can be used comprising a first stage with a non-chromatographic separation train coupled to one or more focusing modulators and further comprising at least one subsequent characterization train comprising at least one chromatographic column.

Further, acts, elements, and features discussed only in connection with one embodiment are not intended to be excluded from a similar role in other embodiments of the invention. Moreover, the invention is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the invention as embodied in the claims.

The use of ordinal terms such as “first,” “second,” “third,” and the like herein, including the claims, to modify an element or component does not by itself connote any priority, precedence, or order of one claim element or component over another, or the temporal order in which acts of a method are performed, but are used merely as labels to distinguish one element, component, or act, having a certain name from another element, component, or act having a same name (but for use of the ordinal term) to distinguish the elements, components, or acts. The terms “comprising,” “including,” “carrying,” “having,” “containing,” and “involving,” as used herein, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims.

Those skilled in the art should appreciate that parameters and/or configurations described herein are exemplary and that actual parameters and/or configurations will depend on the specific application in which the systems and techniques of the invention are used. Those skilled in the art should also recognize or be able to ascertain, using no more than routine experimentation, equivalents to the specific embodiments of the invention.

What is claimed is:

1. A chromatography system for analyzing at least one formation fluid, the system comprising:
a plurality of stages in communication with the at least one formation fluid, such that at least one of the plurality of stages has an input and an output;
one or more detectors having an input and an output, the one or more detectors in communication with the at least one of the plurality of stages;
wherein the chromatography system provides a component analysis of the at least one formation fluid.

2. The formation fluid of claim 1, wherein the at least one formation fluid has components with a plurality of boiling points.

3. The chromatography system of claim 1, further comprising a carrier gas reservoir.

4. The one or more stages of claim 1, wherein the plurality of stages comprise a chromatographic column.

5. The plurality of stages of claim 1, wherein at least one of the plurality of stages comprise a vaporization chamber.

6. The plurality of stages of claim 1, wherein at least one of the plurality of stages further comprises a flow-through bed, a back-flushable bed, an open adsorbent, an absorbent-lined tube, a packed tube, a high permeability membrane, or a MEMS-channel adsorbent coating.

7. The vaporization chamber of claim 5, further comprising a vaporization chamber heater capable of providing a variable temperature.

8. The vaporization chamber of claim 5, wherein the vaporization chamber vaporizes one of all or at least a part of the at least one formation fluid.

9. The vaporization chamber of claim 5, wherein the vaporization chamber has at least one carrier gas inlet in communication with a carrier gas reservoir.

10. The vaporization chamber of claim 5, further comprising a carrier gas control valve.

11. The vaporization chamber of claim 5, wherein the vaporization chamber allows parallel sequential analysis of the at least one formation fluid.

12. The vaporization chamber of claim 5, wherein the vaporization chamber allows parallel simultaneous analysis of the at least one formation fluid.

13. The vaporization chamber of claim 5, further comprising multiple carrier gas inlets.

14. The vaporization chamber of claim 5, wherein the vaporization chamber is sorbent filled.

15. The plurality of stages of claim 1, wherein the plurality of stages are arranged in series.

16. The plurality of stages of claim 1, wherein the plurality of stages are arranged in parallel.

17. The plurality of stages of claim 1, wherein the plurality of stages are in a composite arrangement having both series and parallel arrangements.

18. The plurality of stages of claim 1, wherein at least one of the plurality of stages further comprise at least one temperature control program.

19. The plurality of stages of claim 1, wherein at least one of the plurality of stages further comprise at least one pressure control program.

20. The plurality of stages of claim 1, wherein at least one of the plurality stages further comprise at least one back-flushing control program.

21. The chromatography system of claim 1, further comprising at least one switching valve.

22. The switching valve of claim 21, wherein the at least one switching valve is in communication with at least one of the plurality of stages.

23. The switching valve of claim 21, wherein the at least one switching valve is in communication with at least one of the one or more detectors.

24. The switching valve of claim 21, wherein the at least one switching valve comprises one of a rotary valve, a sliding valve, a set of needle valves or a set of diaphragm valves.

25. The switching valve of claim 21, wherein the at least one switching valve is a Deans switch.

26. The switching valve of claim 21, wherein the operation of the at least one switching valve is in accordance with a predefined timing schedule.

27. The switching valve of claim 21, wherein the operation of the at least one switching valve is in accordance with an adaptive timing schedule.

28. The adaptive timing schedule of claim 27, wherein the adaptive timing schedule is based on monitoring output of at least one detector of the one or more detector.

29. The chromatography system of claim 1, further comprising at least one modulator, wherein the at least one modulator is in communication with the plurality of stages.

30. The at least one modulator of claim 29, wherein the at least one modulator is operated on a predetermined timing schedule.

31. The predetermined timing schedule of claim 30, wherein the predetermined timing schedule is a cycle that is cyclical.

32. The predetermined timing schedule of claim 30, wherein the predetermined timing schedule is a cycle that is non-cyclical.

33. A method for analyzing a formation fluid, the method comprising the steps of:
providing a plurality of stages in communication with the formation fluid, the plurality of stages having at least one input and at least one output;
providing one or more detector having an input and an output, the one or more detector in communication with at least one of the plurality of stages;
generating a component analysis of the formation fluid using the plurality of stages and the one or more detectors; and
storing the component analysis.

34. The method of claim 33, wherein the formation fluid has a plurality of boiling points.
